(19) United States
(12) Patent Application Publication
(10) Pub. No.: US 2014/0052560 A9
(43) Pub. Date: Feb. 20, 2014

(54) TRANSACTION SERVICES REVERSE AUCTION

(71) Applicants: Joseph A. Giordano, Waxhaw, NC (US); Herbert M. Fellman, Charlotte, NC (US)

(72) Inventors: Joseph A. Giordano, Waxhaw, NC (US); Herbert M. Fellman, Charlotte, NC (US)

(73) Assignee: Bank of America, Charlotte, NC (US)

(21) Appl. No.: 13/613,647

(22) Filed: Sep. 13, 2012

Related U.S. Application Data
(63) Continuation of application No. 12/729,388, filed on Mar. 23, 2010.
(60) Provisional application No. 61/184,349, filed on Jun. 5, 2009.

(51) Int. Cl. G06Q 30/08

(52) U.S. Cl. 705/26.4

(57) ABSTRACT

A reverse auction platform for selecting a transaction service is provided. The platform may include a database configured to store a request for a transaction service and to store fee bids corresponding to the transaction service. The platform may also include a memory configured to store execution instructions as well as a processor coupled with the database and the memory. The processor may be configured to execute the instructions. The instructions may be configured to cause the processor to receive a request for a transaction service; to present the request; and to select a transaction service based on a fee bid corresponding to the transaction service.

### CROSS-REFERENCE TO RELATED APPLICATION

This application claims priority from U.S. Provisional Patent Application No. 61/184,349, filed on Jun. 5, 2009, said Provisional Patent Application which is hereby incorporated by reference herein in its entirety.

### FIELD OF TECHNOLOGY

Aspects of the disclosure relate to providing apparatus and methods for selecting auctioning service opportunities in connection with a transaction. In particular, the disclosure relates to apparatus and methods for bidding-out opportunities to participate in the execution of the transaction.

### BACKGROUND

In a typical credit card transaction, a card holder purchases from a merchant or service provider (“the merchant”) goods or services (“the goods”) using credit. The credit is extended to the card holder by an issuing bank (the “issuer”). The merchant presents a debit to an acquiring bank (the “acquirer”). The acquirer pays the merchant for (and thus “acquires”) the goods. A transaction processing network in communication with the issuer and the acquirer settles the transaction between the issuer and the acquirer. The transaction processing network may collect transaction processing network fees from the issuer and the acquirer in connection with the settlement.

The issuer may impose upon the acquirer a fee for participating in the transaction. The fee may be referred to as “interchange.” Interchange may be a fixed fee for the transaction or a percentage of the transaction. Interchange flows from the acquirer, through the transaction processing network, to the issuer. The issuer typically uses interchange to cover costs of acquiring credit card customers, servicing credit card accounts, providing incentives to retain customers, mitigating fraud, covering customer credit risk, group comp and other expenses.

The acquirer may deduct a “transaction fee” from the amount that the acquirer pays the merchant in exchange for the goods. The transaction fee may cover the acquirer's transaction processing network fee, interchange, and other expenses. The acquirer may obtain a profit from the transaction fee.

FIG. 1 shows typical credit card transaction settlement flow 100. At step 1, the merchant provides $100 in goods to the card holder. The card holder (which may be referred to hereinafter as the “customer”) pays with a credit card. At step 2, the issuer transmits to the card holder a statement showing the purchase price ($100.00) due. The issuer collects the purchase price amount, along with interest and fees if appropriate, from the card holder. At step 3, the issuer routes the purchase price amount ($100.00) through the transaction processing network to the acquirer. At step 4, the acquirer partially reimburses the merchant for the purchase price amount. In the example shown in FIG. 1, the partial reimbursement is $98.00. The difference between the reimbursement amount ($98.00 ) and the purchase price amount ($100.00) is a two dollar ($2.00) transaction fee.

At step 5, the acquirer pays an interchange amount ($1.50), via the transaction processing network, to the issuer. At step 6, both the acquirer and the issuer pay a transaction processing network fee ($0.07 for acquirer and $0.05 for the issuer) to the transaction processing network.

TABLE 1
Net positions, by party, based on settlement
flow 100 (shown in FIG. 1).

| Party | Net ($) |
|---|---|
| Issuer | 1.45 |
| Acquirer | 0.43 |
| Transaction processing | 0.12 |
| network | |
| Merchant | −2.00 |

In settlement 100 (shown in FIG. 1), the transaction fee is based on a merchant discount rate of 2%. The $1.50 interchange is based on an interchange rate of 1.5%. The sum of the transaction processing network fees ($0.07 and $0.05 is based on a total transaction processing network fee rate of 12%.

Transaction processing networks and transaction processing network services offered under the trademarks VISA, MASTERCARD, NYCE and PULSE are known. Transaction processing networks typically set interchange rates. Interchange rates often depend for each transaction processing network on merchant type and size, transaction processing method and other factors. Some transaction processing networks set rules that prohibit merchants from charging an incremental fee for credit card payments, establishing minimum or maximum purchase price amounts or refusing to accept selected cards.

Table 2 shows benefits of settlement flow 100 (shown in FIG. 1).

| Party | Benefit |
|---|---|
| Merchant | Access to card holder funds and credit |
| | Timely settlement |
| | Protection from customer fraud and credit risk |
| | Increased purchase price amounts |
| Issuer | Reliable payment platform with broad acceptance |
| | Consistent customer experience across merchants |
| | Predictable source of revenue to support card |
| | issuance costs |
| Card holder | Access to ready funds and credit |
| | Ability to make purchases virtually anywhere |
| | Protection from fraud |
| | Protection from merchant disputes |
| | Reward for card based purchases |

The economic relationships between the entities shown in FIG. 1 define a market that may be made more efficient by increasing visibility amongst the entities.

It would be desirable, therefore, to provide apparatus and methods for executing a reverse auction of transaction services.

### SUMMARY OF THE INVENTION

Apparatus and methods for providing a reverse auction for transaction services are provided. An electronic reverse auction platform for selecting a transaction service may include: a receiver module configured to receive a request for a transaction service; a server module configured to present the request; and a processor module configured to select a transaction service based on a fee bid corresponding to the transaction service.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art process;

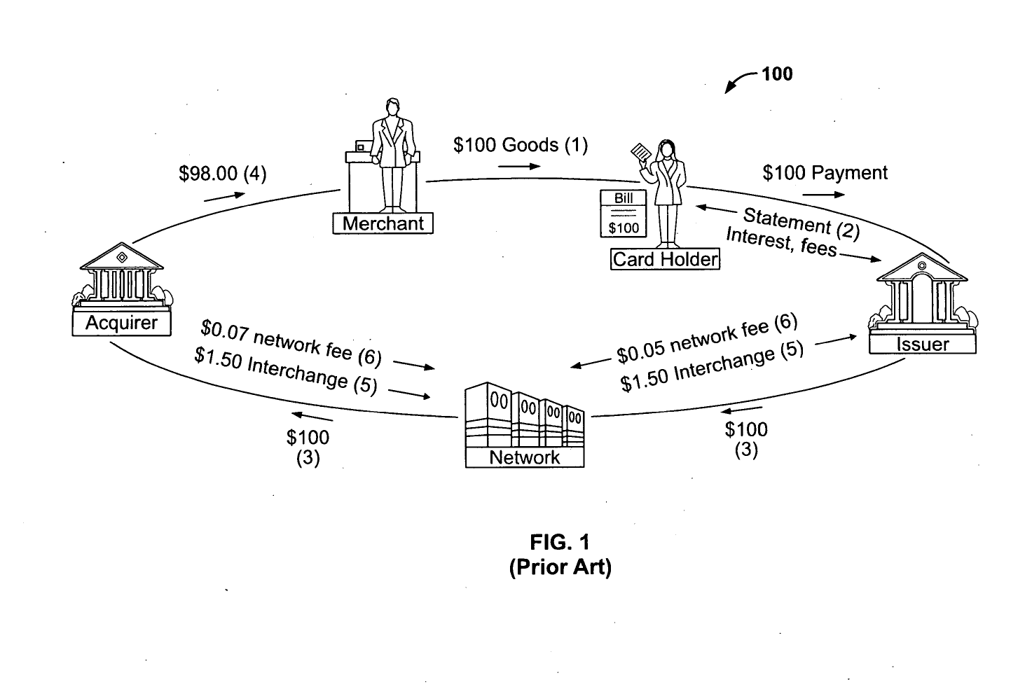

FIG. 2 shows an arrangement in which apparatus and methods in accordance with the principles of the invention may be used;

FIG. 3 shows apparatus in accordance with the principles of the invention;

FIG. 4 shows other apparatus in accordance with the principles of the invention in connection with a first function;

FIG. 5 shows the apparatus of FIG. 4 in connection with a second function;

FIG. 6 shows the apparatus of FIG. 4 in connection with a third function;

FIG. 7 shows the apparatus of FIG. 4 in connection with a fourth function;

FIG. 8 shows still other apparatus in accordance with the principles of the invention;

FIG. 9 shows still other apparatus in accordance with the principles of the invention; and

FIG. 10 shows steps of a process in accordance with the principles of the invention.

### DETAILED DESCRIPTION OF THE INVENTION

Apparatus and methods for selecting a transaction service are provided. The apparatus and methods may involve a receiver module that is configured to receive a request for a transaction service, a server module that is configured to present the request, and a processor module configured to select a transaction service based on a fee bid corresponding to the transaction service.

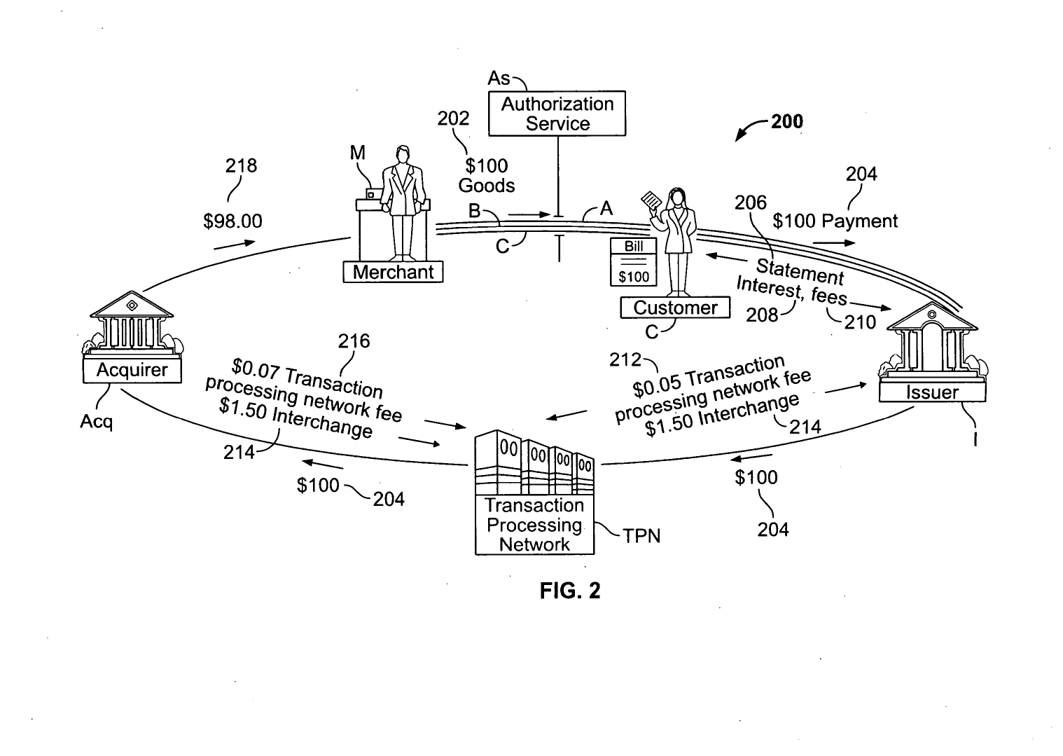

FIG. 2 shows illustrative settlement arrangement 200. Arrangement 200 may include one or more of merchant M, customer C, authorization channels A, B, C, etc., Issuer I, Transaction Processing Network TPN, and acquirer ACQ. Flows of goods 202, payment 204, statement 206, interest 208, fees 210, transaction processing network fee 212, interchange fee 214, transaction processing network fee 216 and purchase amount 218 are shown.

Authorization service AS may provide reconciliation of customer and bank data via one or more of electronic authorization channels A, B, C, etc. The authorization service may charge an authorization fee to the merchant or the issuer. Merchant M may use an authorization channel (A, B, C, e.g.) to obtain authorization of the transaction based on the customer C's account managed by issuer I.

The transaction service may be provided by one of arrangement 200 participants M, AS, C, I, TPN and ACQ to another of the participants. A participant that receives the service may select a supplier of the service based on a value associated with the service. The value may be a fee, a rate, a reward, an incentive, an opportunity and the like, and any suitable combination thereof. A lower fee may correspond to a higher value.

For example, merchant M may require execution of a transaction between merchant M and customer C at the lowest available interchange rate. Different issuers I may provide, via their associated transaction processing networks, different interchange rates. Merchant M may select the issuer that is willing to provide the execution at the lowest interchange rate.

The server module may present merchant M's request to issuers I. In some embodiments, the server module may present the request and issuers I may respond to the request by proffering bids. In some embodiments, the request may be matched to a highest value bid based on previously identified bids and preset rules that may be applied to the previously identified bids. The processor module may be used to select the bid with the highest value to the requesting participant.

Table 3 shows illustrative offer/bid participant pairs, corresponding offer types and bid values.

TABLE 3
Illustrative offer/bid participant pairs,
corresponding offer types and bid values.

| Offer/bid participant pair | Offer type | Bid value |
|---|---|---|
| Merchant-Issuer | Credit issuance | Interchange fee |
| | opportunity | Credit terms for |
| | Promotional | merchant's |
| | opportunity | customer C |
| | | Incentive |
| Merchant-authorization | Transaction | Authorization fee |
| service | authorization | Incentive |
| | opportunity | |
| | Promotional | |
| | opportunity | |
| Merchant-Transaction | Transaction | Interchange fee |
| Processing Network | processing | Incentive |
| | opportunity | |
| | Promotional | |
| | opportunity | |
| Customer-Issuer | Credit issuance | Credit terms |
| | opportunity | Incentive |
| | Promotional | |
| | opportunity | |

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

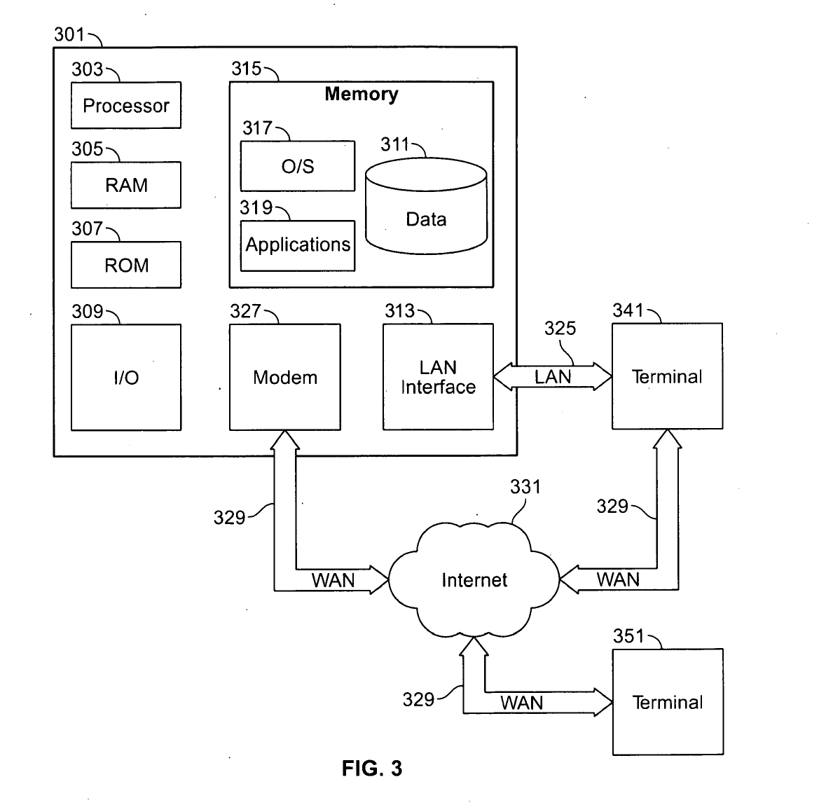

FIG. 3 is a block diagram that illustrates a generic computing device 301 (alternatively referred to herein as a “server”) that may be used according to an illustrative embodiment of the invention. The computer server 301 may have a processor 303 for controlling overall operation of the server and its associated components, including RAM 305, ROM 307, input/output module 309, and memory 325. Server 301 may include one or more receiver modules, server modules and processors that may be configured to receive requests for bids, receive bids, apply rules to match requests for bids and bids, select high value bids and output a selection of a transaction service provider and perform any other suitable tasks related to conducting reverse auctions for transactional services.

Input/output (“I/O”) module 309 may include a microphone, keypad, touch screen, and/or stylus through which a user of device 301 may provide input, and may also include one or more of a speaker for providing audio output and a video display device for providing textual, audiovisual and/or graphical output. Software may be stored within memory 325 and/or storage to provide instructions to processor 303 for enabling server 301 to perform various functions. For example, memory 325 may store software used by server 301, such as an operating system 317, application programs 319, and an associated database 321. Alternatively, some or all of server 301 computer executable instructions may be embodied in hardware or firmware (not shown). As described in detail below, database 321 may provide storage for customer information, transaction information, merchant information, transaction fee information, transaction fee factors and any other suitable information.

Server 301 may operate in a networked environment supporting connections to one or more remote computers, such as terminals 341 and 351. Terminals 341 and 351 may be personal computers or servers that include many or all of the elements described above relative to server 301. The network connections depicted in FIG. 3 include a local area network (LAN) 325 and a wide area network (WAN) 329, but may also include other networks. When used in a LAN networking environment, computer 301 is connected to LAN 325 through a network interface or adapter 323. When used in a WAN networking environment, server 301 may include a modem 327 or other means for establishing communications over WAN 329, such as Internet 331. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 319, which may be used by server 301, may include computer executable instructions for invoking user functionality related to communication, such as email, short message service (SMS), and voice input and speech recognition applications.

Computing device 301 and/or terminals 341 or 351 may also be mobile terminals including various other components, such as a battery, speaker, and antennas (not shown).

Terminal 351 and/or terminal 341 may be portable devices such as a laptop, cell phone, blackberry, or any other suitable device for storing, transmitting and/or transporting relevant information.

Any information described above in connection with database 321, and any other suitable information, may be stored in memory 325.

One or more of applications 319 may include one or more algorithms that may be used to receive requests for bids, receive bids, apply rules to match requests for bids and bids, select high value bids and output a selection of a transaction service provider and perform any other suitable tasks related to executing a reverse auction for transactional services.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

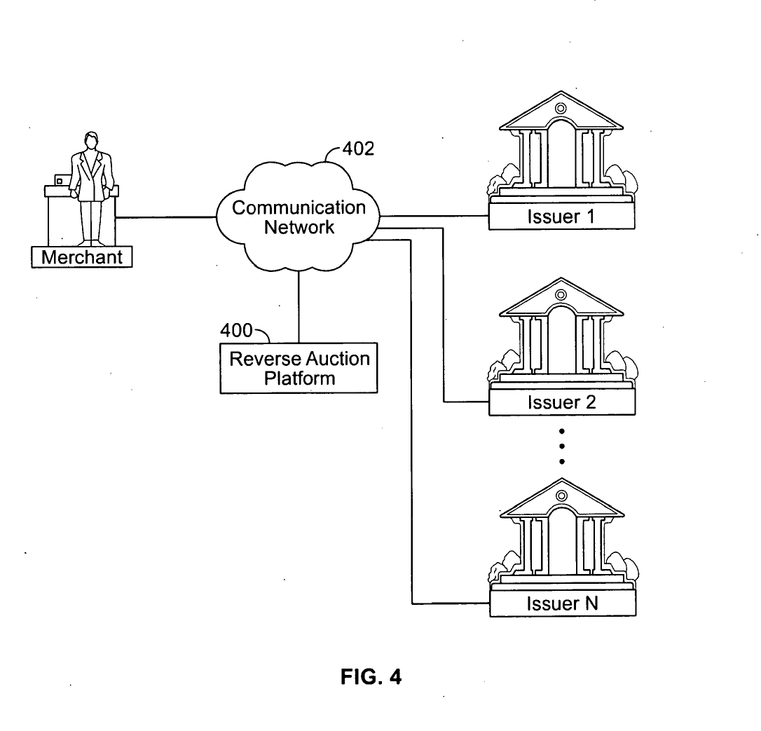

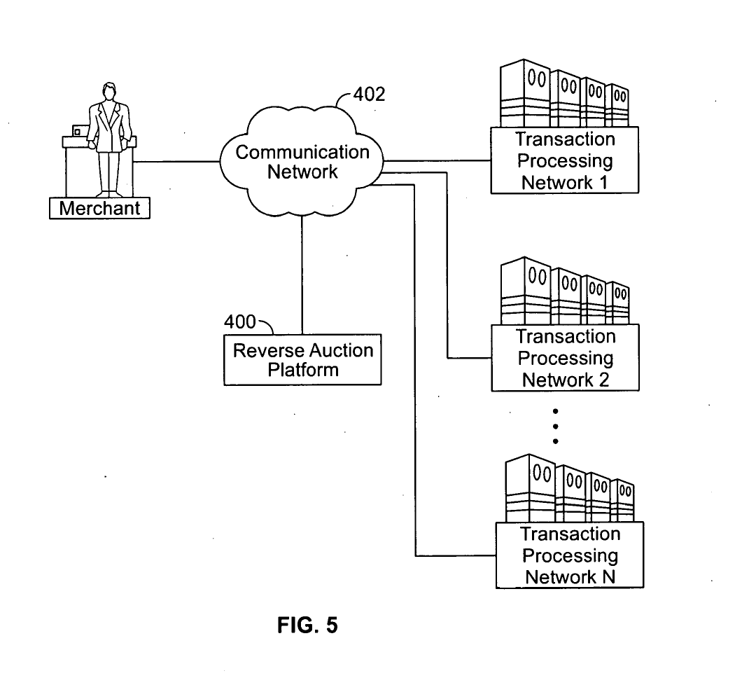

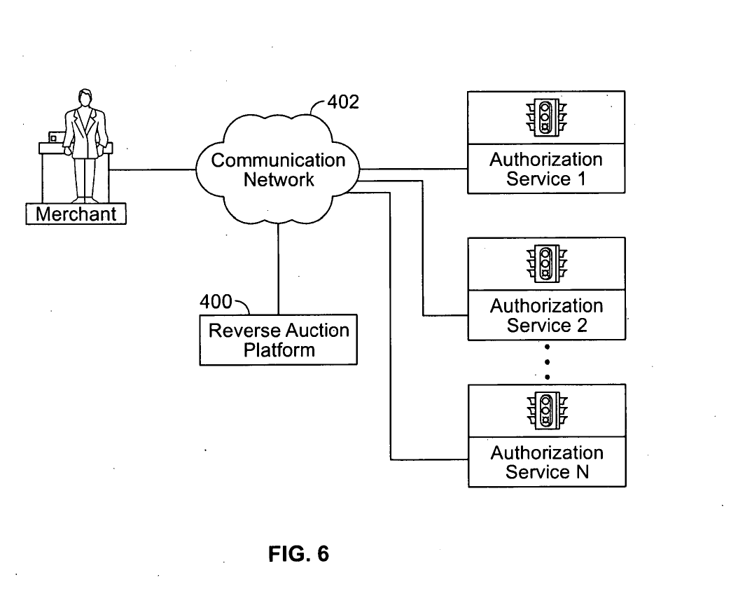

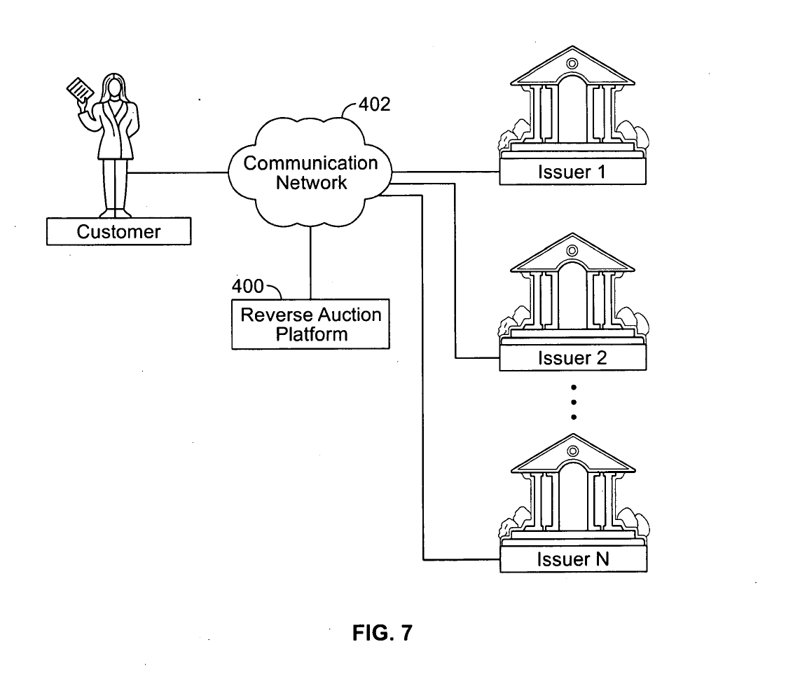

FIGS. 4-7 show illustrative reverse auction platform 400 in electronic communication, via communication network 402, with an offeror (merchant M in FIGS. 4-6, customer C in FIG. 7) and multiple bidders (Issuers 1-N in FIGS. 4 and 7, transaction processing networks 1-N in FIG. 5 and authorization services 1-N in FIG. 6). Reverse auction platform 400 may include one or more of the features and/or devices shown in FIG. 3.

Reverse auction platform 400 (shown in FIG. 4) may be in communication with one or more systems for processing and communicating transaction fee information. For example, reverse auction platform 400 may intervene, either in a software or a hardware sense, between merchant-based equipment for processing transaction information at a point-of-sale and one or more of transaction processing network equipment, issuer equipment and authorization service equipment.

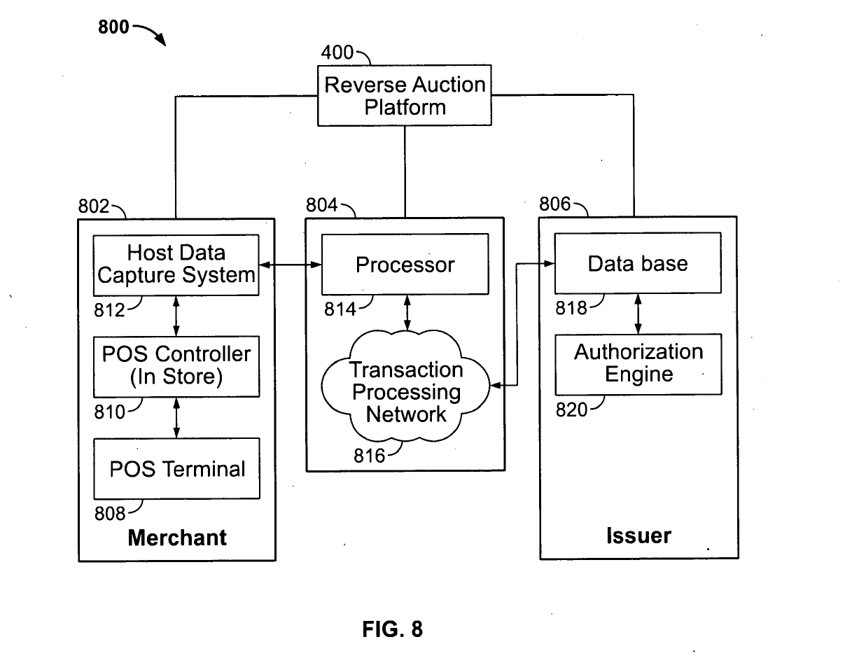

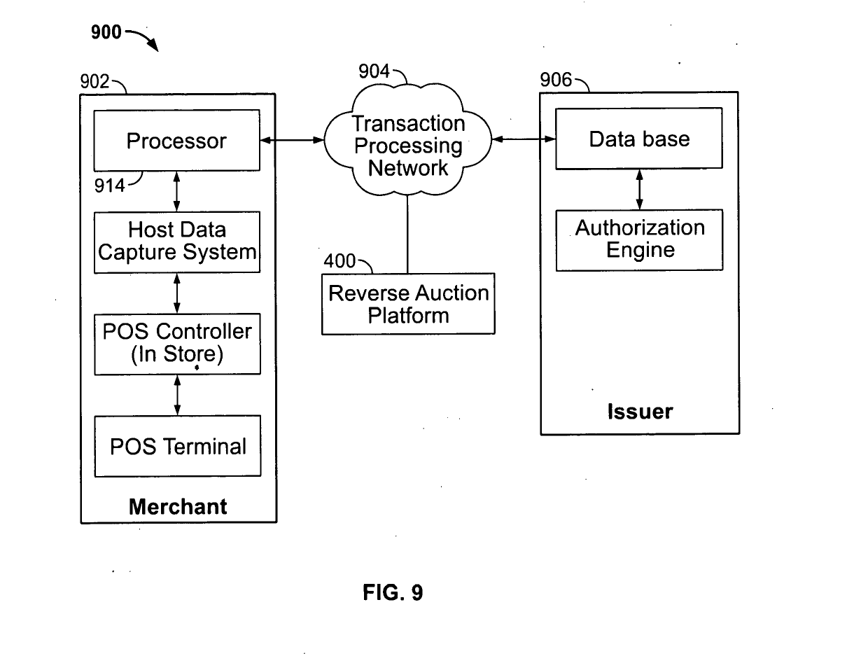

FIGS. 8 and 9 show illustrative systems for processing and communicating transaction fee information. One or more of the elements shown in FIGS. 8 and 9 may include or involve one or more of the elements or features shown and described in connection with FIG. 3.

FIG. 8 shows illustrative system 800 for processing and communicating transaction fee information. System 800 may include merchant component 802, transaction processing network component 804 and issuer component 806. In general, a system such as 800 may include many merchant components such as 802 and many issuer components such as 806.

A customer may purchase goods by transferring customer information from a personal data storage device, such as a credit card, to POS terminal 808. POS terminal 808 may read the customer information from the card. The customer information may include issuer information, account information and any other suitable information.

POS terminal 808 may transmit transaction information to POS controller 810. The transaction information may include some or all of the customer information and any other suitable information, such as the transaction amount and information regarding the purchased goods.

POS controller 810 may act as a server for providing user prompts and display layout information to one or more POS terminals such as POS terminal 808. POS controller 810 may receive transaction information from one or more of the POS terminals.

POS controller 810 may transmit the transaction information to host data capture system 812. Host data capture system 812 may store transaction information from POS controller 810. Host data capture system 812 may store accounting data, inventory data and other suitable data that may be included in the transaction information.

Host data capture system 812 may route merchant information to processor 814. Processor 814 may include a credit card transaction processing network “processor,” which is known to those of ordinary skill in the art. The illustrative systems shown in FIGS. 8 and 9 may include one or more other processors that perform tasks that are appropriate for the components thereof. The merchant information may include some or all of the transaction information. The merchant information may include information about the merchant, the merchant's business, the merchant's transaction processing network membership, the merchant's business behavior and any other suitable information. Processor 814 may route some or all of the merchant information, via transaction processing network 816, to database 818. The routing may be governed by transaction information. For example, the routing may be governed by a bank issuer number (“BIN”) that is encoded in the customer's credit card. Authorization engine 820 may render a transaction authorization decision based on the merchant information.

Authorization engine 820 may transmit authorization information back to POS terminal 808 through transaction processing network 816, processor 814, host data capture system 812 and POS controller 810. The authorization information may include the authorization decision (e.g., “GRANTED” or “DENIED”). The authorization information may include some or all of the merchant information. The merchant information may be used by processor 814 to route the authorization information back to the merchant and the POS terminal where the customer is present.

Transaction fee information may include some or all of the information that is necessary to identify the transaction fee for the transaction. The transaction fee may depend on one or more transaction fee factors, such as interchange rate, transaction processing network rates, merchant type, merchant size, transaction processing method, and any other suitable factors. Transaction fee information may include one or more of the foregoing factors and any other suitable factors.

The transaction fee information may be stored in any suitable element of merchant component 802, transaction processing network component 804 and issuer component 806. For example, transaction fee information may be stored in processor 814. Processor 814 may include algorithms that may be used in conjunction with the transaction fee information to identify the transaction fee corresponding to the customer transaction taking place at POS terminal 808. After the transaction fee is identified, processor 814 may transmit the transaction fee, via merchant components 802, to POS terminal 808. POS terminal 808 may display the transaction fee for viewing by the customer.

POS terminal may have one or more interactive features that the customer may use. The features may provide the customer with information that may help the customer decide whether to execute the transaction. The customer may use the features to obtain more information about the merchant, the transaction, the transaction fee, transaction fees associated with different purchasing instruments (e.g., credit cards, debit cards, instruments or devices that include a contact chip, such as an ISO14443-compliant contactless chip, or other electronic purchasing devices) or other suitable information.

Purchasing instruments may store data in a magnetic strip, a bar code, a silicon chip or any other suitable data storage device or format.

FIG. 9 shows illustrative system 900 for processing and communicating transaction fee information. System 900 may include merchant component 902, transaction processing network component 904 and issuer component 906. In general, a system such as 900 may include many merchant components such as 902 and many issuer components such as 906. System 900 may have one or more of the features that are described herein in connection with system 300.

In system 900, processor 914 may be present in merchant component 902. Corresponding processor 814 is present in transaction processing network component 804 (shown in FIG. 8). Systems such as 800 are designed for merchants that require high throughput of merchant information and transaction fee information. Systems such as 900 are designed for merchants that do not require high throughput of merchant information and transaction fee information.

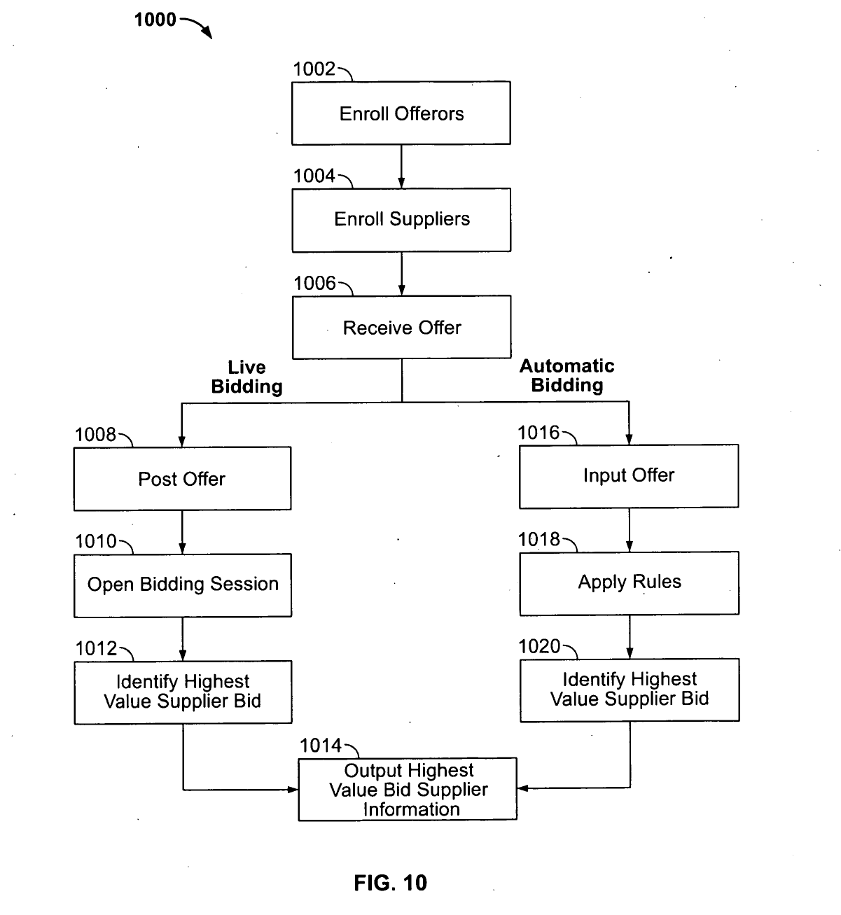

Processes in accordance with the principles of the invention may include one or more features of the process illustrated in FIG. 10. For the sake of illustration, the steps of the process illustrated in FIG. 10 will be described as being performed by a “system”. The “system” may include one or more of the features of the apparatus that are shown in FIGS. 2-9 and/or any other suitable device or approach. The “system” may be provided by an entity. The entity may be an individual, an organization or any other suitable entity.

FIG. 10 shows illustrative process 1000 for conducting a reverse auction for transaction services. Process 1000 may begin at step 1002. At step 1002, offerors may be enrolled. Offerors may include any of the participants in arrangement 200 (shown in FIG. 2) or any other suitable entities. At step 1004, suppliers may be enrolled. Suppliers may include any of the participants in arrangement 200 (shown in FIG. 2) or any other suitable entities. At step 1006, the system may receive an offer such as an offer of a type identified in Table 3 or any other suitable offer. The offer may be received, for example, from merchant component 800 (shown in FIG. 8) or merchant component 900 (shown in FIG. 9). When customer C is offeror, customer C may provide a request for services, for example, via a POS terminal such as those shown in FIGS. 8 and 9, communication network 402 (shown in FIG. 4), a PDA, a cell phone or any other suitable device.

In some embodiments, the system may provide live bidding. In such embodiments, process 1000 may continue at step 1008. At step 1008, the offer may be posted for viewing by suppliers. At step 1010, a bidding session may be opened. The suppliers may bid values such as those of the types identified in Table 3 or any other suitable values. At step 1012, the system may identify the highest value supplier bid. At step 1014, the system may output the highest value bid supplier information. The system may output the highest value bid supplier information, for example, to merchant component 800 (shown in FIG. 8) or merchant component 900 (shown in FIG. 9). The merchant component may then drive the transaction to completion using approaches discussed in connection with FIGS. 8 and 9.

In some embodiments, the system may provide automatic bidding. In those embodiments, process 1000 may continue at step 1016. At step 1016, the offer may be input into a bid-offer engine (software or hardware). At step 1018, rules may be applied to apply bids to the offer. (For example, bids may be screened for appropriateness, goodness of match to the bid, quantitative overall value (for example if they include a fee amount and an incentive) or other metrics. Offers may be screened for offeror qualifications, creditworthiness, past behavior and other criteria.) At step 1020, the highest value supplier bid may be identified. Process 1000 may continue at step 1014, which is described above.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for providing a reverse auction platform for selecting a transaction service have been provided. Persons skilled in the art will appreciate that the present invention can be practiced by other than the described embodiments, which are presented for purposes of illustration rather than of limitation. The present invention is limited only by the claims that follow.

What is claimed is:

1. An electronic reverse auction platform for selecting a transaction service, the platform comprising:
an electronic receiver configured to receive a request for a credit card related credit issuance service or a debit card related credit issuance service;
a server, in communication with said receiver, said server for presenting the request;
a processor configured to select a credit card related credit issuance service or a debit card related credit issuance service based on a fee bid corresponding to the credit card related credit issuance service or the debit card related credit issuance service; and
wherein, in response to the selection of the credit card related credit issuance service or the debit related credit issuance service, the receiver is further configured to receive a communication that a transaction associated with either the credit card related credit issuance service or the debit card related credit issuance service is authorized.

2. The reverse auction platform of claim 1 wherein, when the fee bid is one of multiple fee bids:
the receiver is further configured to receive the multiple fee bids; and
the processor is further configured to select either the credit card related credit issuance service or the debit related credit issuance service when the one fee bid is the least of the multiple fee bids.

3. The reverse auction platform of claim 2 wherein:
the server presents the request to an identified set of transaction service providers; and
the receiver receives the multiple fee bids in response, at least in part, to the presentation of the request.

4. The reverse auction platform of claim 1 wherein the receiver is further configured to receive from a merchant a request for a settlement service and to receive a bid related to said settlement service.

5. The reverse auction platform of claim 1 wherein the receiver is further configured to receive from a merchant a request for an authorization service and to receive a bid related to said authorization service.

6. The reverse auction platform of claim 1 wherein the receiver is further configured to receive from a merchant a request for an acquisition service and to receive a bid related to said acquisition service.

7. An electronic reverse auction platform for selecting a transaction service, the platform comprising:
an electronic receiver configured to receive a request for a credit card related credit issuance service or a debit card related credit issuance service;
a server, in communication with said receiver, said server for presenting the request;
a processor configured to select a credit card related promotional opportunity or a debit card related promotional opportunity based on a fee bid corresponding to the credit card related promotional opportunity or the debit card related promotional opportunity; and
wherein, in response to the selection of the credit card related promotional opportunity or the debit related promotional opportunity, the receiver is further configured to receive a communication that a transaction associated with either the credit card related promotional opportunity or the debit card related promotional opportunity is authorized.

8. The reverse auction platform of claim 7 wherein, when the fee bid is one of multiple fee bids:
the receiver is further configured to receive the multiple fee bids; and
the processor is further configured to select either the credit card related promotional opportunity or the debit related promotional opportunity when the one fee bid is the least of the multiple fee bids.

9. The reverse auction platform of claim 8 wherein:
the server presents the request to an identified set of transaction service providers; and
the receiver receives the multiple fee bids in response, at least in part, to the presentation of the request.

10. The reverse auction platform of claim 7 wherein the receiver is further configured to receive from a merchant a request for a settlement service and to receive a bid related to said settlement service.

11. The reverse auction platform of claim 7 wherein the receiver is further configured to receive from a merchant a request for an authorization service and to receive a bid related to said authorization service.

12. The reverse auction platform of claim 7 wherein the receiver is further configured to receive from a merchant a request for an acquisition service and to receive a bid related to said acquisition service.
